(19) United States
(12) Patent Application Publication
(10) Pub. No.: US 2024/0402440 A1
(43) Pub. Date: Dec. 5, 2024

(54) OPTICAL RECEPTACLE, OPTICAL MODULE AND TRANSMISSION APPARATUS

(71) Applicant: Enplas Corporation, Saitama (JP)

(72) Inventor: Tomohiro SAITO, Saitama (JP)

(73) Assignee: Enplas Corporation, Saitama (JP)

(21) Appl. No.: 18/670,856

(22) Filed: May 22, 2024

(30) Foreign Application Priority Data
May 30, 2023 (JP) 2023-088582

(51) Int. Cl. G02B 6/42

(52) U.S. Cl. CPC G02B 6/4214

(57) ABSTRACT

An optical receptacle includes an incidence surface and an emission surface. R1/|R2|>1.5 (Equation 1) and T/(R1+R2)>1.5 (Equation 2) are satisfied, where R1 is a curvature radius of a center of the incidence surface, R2 is a curvature radius of a center of the emission surface, and T is a light path length between the center of the incidence surface and the center of the emission surface.

This application claims the benefit of priority of Japanese Patent Application No. 2023-088582, filed on May 30, 2023, the disclosure of which including the specification, drawings and abstract is incorporated herein by reference in its entirety.

### TECHNICAL FIELD

The present invention relates to an optical receptacle, an optical module and a transmission apparatus.

### BACKGROUND ART

In the related art, an optical receptacle for optically connecting a surface-emitting laser (e.g., vertical-cavity surface-emitting laser (VCSEL)) and an optical transmission member, or for optically connecting optical transmission members is used for optical communications using optical transmission members such as optical fibers and optical waveguides (see, for example, PTL 1).

PTL 1 discloses an optical signal transmission system in which a signal light emitted from a laser diode is transmitted to an optical receptacle through a transmission fiber, an optical connector (optical receptacle), and a reception fiber. The optical connector disclosed in PTL 1 is made of glass, and includes two planoconvex lenses with convex surfaces facing each other. Light emitted from the transmission fiber is controlled to be parallel light at one planoconvex lens, and impinges on the other planoconvex lens. The light incident on the other planoconvex lens is controlled to be focused. The light controlled by the other planoconvex lens enters a reception fiber.

### CITATION LIST

### Patent Literature

PTL 1

WO2017/002149

### SUMMARY OF INVENTION

### Technical Problem

While the optical connector disclosed in PTL 1 is made of glass, it is also conceivable to integrally mold it with a resin. If the optical connector disclosed in PTL 1 is integrally molded with a resin, the refractive index of the optical connector at the wavelengths used may change depending on the use environment. For example, in the case where the material used for the optical connector is polyetherimide (PEI), the refractive index is changed by approximately 0.007 when the environmental temperature is changed from 0° C. to 80° C. Generally, products are designed such that the property is optimized at normal temperature (25° C.) or the temperature of an intermediate state of the environmental temperature. However, when the refractive index of the material used in the optical connector is changed due to the use environment as described above, the light focal position of light emitted from the optical connector is shifted from the designed optimum position, thus reducing the coupling efficiency. As a result, problems may occur during actual use.

In view of this, an object of the present invention is to provide an optical receptacle that can suppress the positional displacement of the focal point of light emitted from the optical receptacle even when the refractive index of the material used is changed. In addition, another object of the present invention is to provide an optical module and a transmission apparatus that include the optical receptacle.

### Solution to Problem

[1] An optical receptacle made of resin and configured to optically couple a light-emitting element and an end surface of an optical transmission member when the optical receptacle is disposed between the light-emitting element and the optical transmission member, the optical receptacle including: an incidence surface that is a convex surface configured to allow incidence of light emitted from the light-emitting element; an emission surface that is a convex surface configured to emit, toward the end surface of the optical transmission member, light incident on the incidence surface, in which the following Equation 1 and Equation 2 are satisfied:

$$R 1 / \vert R 2 \vert > 1.5 , and \qquad ( Equation 1 )$$

$$T / ( R 1 + R 2 ) > 1.5 \qquad ( Equation 2 )$$

where R1 is a curvature radius of a center of the incidence surface, R2 is a curvature radius of a center of the emission surface, and T is a light path length between the center of the incidence surface and the center of the emission surface.

[2] The optical receptacle according to [1], in which a focal length of the optical receptacle is a negative number.

[3] An optical module including: a light-emitting element; and the optical receptacle according to [1] or [2] where light emitted from the light-emitting element enters, in which the following Equation 3 is satisfied

$$E 1 / E 2 > 12 \qquad ( Equation 3 )$$

where E1 is a diameter on the incidence surface of light emitted from the light-emitting element that impinges on the incidence surface, and E2 is a diameter on the emission surface of light emitted from the light-emitting element that is emitted from the emission surface.

[4] The optical module according to [3], in which in a cross section including an optical axis of the light-emitting element, a center of the incidence surface and a center of the emission surface, light emitted from a center of a light-emitting surface of the light-emitting element includes light that intersects the optical axis in a region between the incidence surface and the emission surface.

[5] The optical module according to [3] or [4], further including a reflection surface configured to reflect, toward the emission surface, light having entered from the incidence surface.

[6] A transmission apparatus including: the optical module according to [3] to [5]; and an optical transmission member where light emitted from the optical receptacle impinges, in which the following Equation 4 is satisfied,

$$D 1 / D 2 > 5 \qquad ( Equation 4 )$$

where D1 is a distance between a center of a light-emitting surface of the light-emitting element and a center of the incidence surface, and D2 is a distance between a center of the emission surface and the end surface of the optical transmission member.

### Advantageous Effects of Invention

According to the present invention, the positional displacement of the focal point

of light emitted from the optical receptacle can be suppressed even when the refractive index is changed.

### BRIEF DESCRIPTION OF DRAWINGS

FIGS. 1A and 1B are diagrams illustrating a configuration of a transmission apparatus of Embodiment 1;

FIGS. 2A to 2D are diagrams for describing light paths in the transmission apparatus of Embodiment 1;

FIGS. 3A to 3C are diagrams illustrating light paths in a transmission apparatus of a comparative example;

FIGS. 4A to 4C are diagrams illustrating a configuration of a transmission apparatus of other example (1) of Embodiment 1;

FIGS. 5A to 5C are diagrams illustrating a configuration of a transmission apparatus of other example (2) of Embodiment 1;

FIGS. 6A to 6C are diagrams illustrating a configuration of a transmission apparatus of other example (3) of Embodiment 1;

FIGS. 7A to 7C are graphs showing a simulation result of other example (3) of Embodiment 1;

FIGS. 8A to 8C are graphs showing a simulation result of a comparative example; FIGS. 9A to 9C are diagrams illustrating a configuration of a transmission apparatus of Embodiment 2;

FIGS. 10A to 10C are diagrams illustrating a configuration of a transmission apparatus of Embodiment 3; and

FIG. 11 is a diagram illustrating a configuration of a transmission apparatus of Embodiment 4.

### DESCRIPTION OF EMBODIMENTS

An optical receptacle, an optical module and a transmission apparatus according to embodiments of the present invention are elaborated below with reference to the accompanying drawings.

### Embodiment 1

### Configuration of Transmission Apparatus

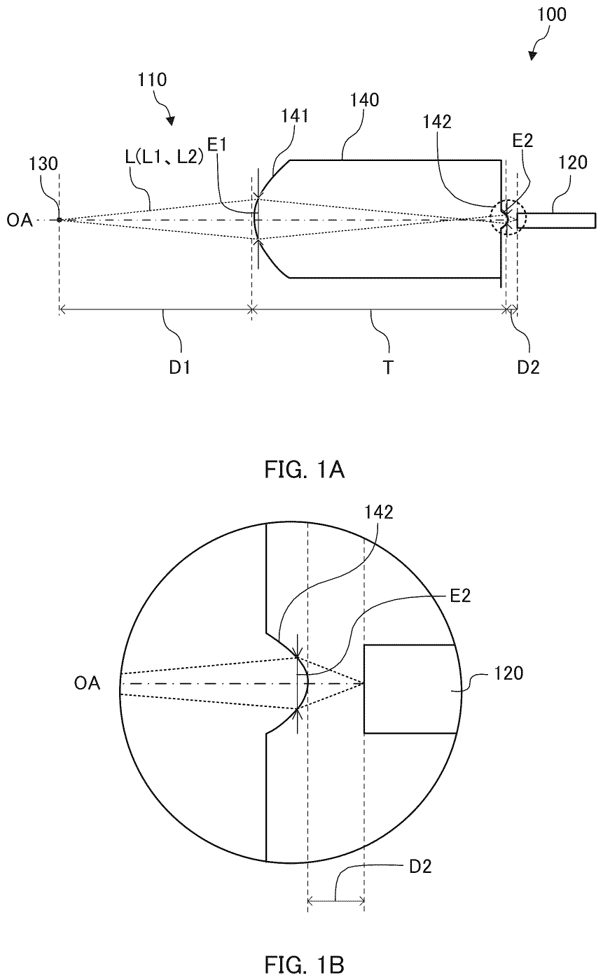

FIG. 1 is a diagram illustrating a configuration of transmission apparatus.

As illustrated in FIG. 1, transmission apparatus 100 includes optical module 110 and optical transmission member 120. Optical module 100 includes light-emitting element 130 and optical receptacle 140.

Light-emitting element 130 emits light with a predetermined wavelength. Light-emitting element 130 is a vertical-cavity surface-emitting laser (VCSEL), for example. In the present embodiment, light-emitting element 130 is fixed to a substrate that is not illustrated in the drawing. The number of light-emitting elements 130 is not limited. One light-emitting element 130, or a plurality of light-emitting elements 130 may be provided.

In the present embodiment, one light-emitting element 130 is provided. Note that in the case where a plurality of light-emitting elements 130 is provided, the number of light-emitting elements 130 is the same as the number of incidence surfaces 141, the number of emission surfaces 142, and the number of optical transmission members 120 of optical receptacle 140 described later. In addition, in the following description, light, except for the light beam along optical axis OA, that is emitted from the center of the light-emitting surface of light-emitting element 130 so as to impinge on incidence surface 141, travel inside optical receptacle 140, and be emitted from emission surface 142 may be referred to as first light beam L1, and light that is emitted from the center of the light-emitting surface of light-emitting element 130 toward the outside of incidence surface 141 than first light beam L1 so as to impinge on incidence surface 141 and be emitted from emission surface 142 may be referred to as second light beam L2. In addition, all light beams emitted from the light-emitting surface of light-emitting element 130 may be referred to simply as light L.

Optical receptacle 140 is disposed between light-emitting element 130 and optical transmission member 120. Optical receptacle 140 is a biconvex lens that optically couples the light-emitting surface of light-emitting element 130 and the end surface of optical transmission member 120. The focal length of optical receptacle 140 of the present embodiment is a negative number. More specifically, in the present embodiment, the focal length of optical receptacle 140 in a standard state (normal temperature) is −0.04 mm. The standard state as used herein means that it is produced as designed at normal temperature. Optical receptacle 140 is formed of a resin that is optically transparent to light with wavelengths used for optical communications. Examples of the material of optical receptacle 140 include polyetherimide (PEI) such as ULTEM (registered trademark) and transparent resin such as cyclic olefin resin. In addition, optical receptacle 140 may be manufactured by being integrally molded through injection molding, for example. Optical receptacle 140 includes incidence surface 141 and emission surface 142.

The central axis of incidence surface 141 and the central axis of emission surface 142 may or may not coincide with each other. In the present embodiment, the central axis of incidence surface 141 and the central axis of emission surface 142 coincide with each other.

Incidence surface 141 is an optical surface that allows light L emitted from light-

emitting element 130 to enter optical receptacle 140. Incidence surface 141 refracts toward optical axis OA light L emitted from light-emitting element 130. Incidence surface 141 is disposed to face light-emitting element 130. The number of incidence surfaces 141 is the same as the number of light-emitting elements 130. That is, in the present embodiment, one incidence surface 141 is provided.

The shape of incidence surface 141 is a convex lens surface protruding toward light-emitting element 130. In addition, in the present embodiment, incidence surface 141 has a circular plan shape. The central axis of incidence surface 14 may be perpendicular to the light-emitting surface of light-emitting element 130 (parallel to the optical axis of light-emitting element 130), or may not be perpendicular to the light-emitting surface of light-emitting element 130. In the present embodiment, the central axis of incidence surface 14 is perpendicular to the light-emitting surface of light-emitting element 130. In addition, the central axis of incidence surface 141 may coincide with the optical axis of light emitted from light-emitting element 130 (the central axis of the light-emitting surface of light-emitting element 130), or may not coincide with the optical axis of light emitted from light-emitting element 130. In the present embodiment, the central axis of incidence surface 141 coincides with the optical axis of light emitted from light-emitting element 130 (the central axis of the light-emitting surface of light-emitting element 130).

Light L having entered from incidence surface 141 travels toward emission surface 142. As elaborated later, light L having entered from incidence surface 141 may or may not intersect optical axis OA in the region between incidence surface 141 and emission surface 142 (inside optical receptacle 140). In other words, in the cross section including optical axis OA of light-emitting element 130, the center of incidence surface 141 and the center of emission surface 142, the incidence position on incidence surface 141 of light L emitted from the region other than the center of the light-emitting surface of light-emitting element 130, and the incidence position on emission surface 142 of light L may be positions on the opposite sides or positions on the same side with respect to optical axis OA. In the present embodiment, light L having entered from incidence surface 141 intersects optical axis OA in the region between incidence surface 141 and emission surface 142 (inside optical receptacle 140).

Emission surface 142 is an optical surface for emitting toward the end surface of optical transmission member 120 light L that has entered from incidence surface 141 and travelled inside optical receptacle 140. Emission surface 142 is disposed to face the end surface of optical transmission member 120. The number of emission surfaces 142 is the same as the number of incidence surfaces 141. That is, in the present embodiment, one emission surface 142 is provided.

The shape of emission surface 142 is a convex lens surface protruding toward the end surface of optical transmission member 120. In addition, emission surface 142 has a circular plan shape. The central axis of emission surface 142 may be perpendicular to the end surface of optical transmission member 120 or may not be perpendicular to the end surface of optical transmission member 120. In addition, the central axis of emission surface 142 may or may not coincide with the central axis of optical transmission member 120. In the present embodiment, the central axis of emission surface 142 is perpendicular to the end surface of optical transmission member 120, and the central axis of emission surface 142 coincides with the central axis of optical transmission member 120. In addition, the central axis of emission surface 142 may coincide with the central axis of the end surface of optical transmission member 120 where emitted light impinges, or may not coincide with the central axis of the end surface of optical transmission member 120 where emitted light impinges. In the present embodiment, the central axis of emission surface 142 coincides with the central axis of the end surface of optical transmission member 120 where emitted light impinges.

The type of optical transmission member 120 is not limited. Examples of the type of optical transmission member 120 include optical fibers and optical waveguides. In the present embodiment, optical transmission member 120 is an optical fiber. In addition, the optical fiber may be of single mode type, or multiple mode type. In the present embodiment, optical transmission member 120 is an optical fiber of single mode type.

Preferably, transmission apparatus 100 satisfies the following Equation 1, more preferably Equation 1A, where R1 is the curvature radius of the center of incidence surface 141, and R2 is the curvature radius of the center of emission surface 142.

$$R 1 / \vert R 2 \vert > 1.5 \qquad ( Equation 1 )$$

$$R 1 / \vert R 2 \vert > 3.5 \qquad ( Equation 1 A )$$

It is preferable that the difference between curvature radius R1 of the center of incidence surface 141 and curvature radius R2 of the center of emission surface 142 be large in this manner. When curvature radius R1 of the center of incidence surface 141 and curvature radius R2 of the center of emission surface 142 satisfy the relationship described above, the refractive power at emission surface 142 can be set strong, and thus distance D2 between emission surface 142 and the end surface of optical transmission member 120 can be set small. This can reduce the influence of a change of D2 due to a change of light (beam) incident on the emission surface and a change of D1. Positional displacement of the focal points of light emitted from optical receptacle 140 can be suppressed. In the present embodiment, R1/|R2| is 12.5. Note that |R2|/R1 is 0.080.

In addition, preferably, transmission apparatus 100 satisfies the following Equation 2, more preferably Equation 2A, where R1 is the curvature radius of the center of incidence surface 141, R2 is the curvature radius of the center of emission surface 142, and T is the light path length between the center of incidence surface 141 and the center of emission surface 142.

$$T / ( R 1 + R 2 ) > 1.5 \qquad ( Equation 2 )$$

$$T / ( R 1 + R 2 ) > 4 \qquad ( Equation 2 A )$$

In this manner, light path length T between the center of incidence surface 14 and the center of emission surface 142 is large with respect to the sum of curvature radius R1 of the center of incidence surface 141 and curvature radius R2 of the center of emission surface 142. That is, optical receptacle 140 of the present embodiment is different from ball lenses. When curvature radius R1 of the center of incidence surface 141, curvature radius R2 of the center of emission surface 142, and light path length T between the center of incidence surface 14 and the center of emission surface 142 satisfy the above-described relationship, light path length T between the center of incidence surface 141 and the center of emission surface 142 can be set large. In this manner, the light beam passing through emission surface 142 can be brought closer to optical axis OA, and as a result a small curvature radius can be selected for the shape of the optical surface of emission surface 142. In the present embodiment, T/(R1+R2) is 4.815. In addition, in the present embodiment, light path length T between the center of incidence surface 141 and the center of emission surface 142 is 1.3 mm.

Curvature radius R1 of the center of incidence surface 141 is not limited as long as the above-mentioned condition is satisfied. Preferably, curvature radius R1 of the center of incidence surface 141 is within a range of 0.1 to 0.5 mm, more preferably within a range of 0.1818 to 0.25 mm. In the present embodiment, curvature radius R1 of the center of incidence surface 141 is 0.25 mm.

Diameter E1 on light incidence surface 141 of light emitted from light-emitting element 130 that impinges on incidence surface 141 is not limited. In the present embodiment, diameter E1 on light incidence surface 141 of light emitted from light-emitting element 130 that impinges on incidence surface 141 is 0.202 mm. Here, diameter E1 on light incidence surface 141 of light emitted from light-emitting element 130 that impinges on incidence surface 141 means the diameter of the irradiation spot of light emitted from the light-emitting surface of light-emitting element 130 that has reached incidence surface 141.

In addition, distance D1 between the light-emitting surface of light-emitting element 130 and the center of incidence surface 141 is not limited. Preferably, distance D1 between the light-emitting surface of light-emitting element 130 and the center of incidence surface 141 is within a range of 0.1 to 2 mm, more preferably within a range of 0.745 to 1.0 mm. In the present embodiment, the distance between the light-emitting surface of light-emitting element 130 and the center of incidence surface 141 is 1.0 mm.

Curvature radius R2 of the center of emission surface 142 is not limited as long as the above-mentioned condition is satisfied. Preferably, curvature radius R2 of the center of emission surface 142 is within a range of −0.1 to −0.5 mm, more preferably within a range of −0.02 to −0.235 mm. In the present embodiment, curvature radius R2 of the center of emission surface 142 is −0.02 mm. Note that in the present embodiment, the curvature radius is formed to decrease in the direction from the center of emission surface 142 toward the outside.

Distance D2 between the center of emission surface 142 and the center of the end surface of optical transmission member 120 is not limited. Preferably, distance D2 between the center of emission surface 142 and the center of the end surface of optical transmission member 120 is within a range of 0.01 to 0.3 mm, more preferably within a range of 0.042 to 0.180 mm. In the present embodiment, distance D2 between the center of emission surface 142 and the center of the end surface of optical transmission member 120 is 0.042 mm.

Diameter E2 on emission surface 142 of light L emitted from light-emitting element 130 that is emitted from emission surface 142 is not limited. In the present embodiment, diameter E2 on emission surface 142 of light L emitted from light-emitting element 130 that is emitted from emission surface 142 is 0.040 mm. Here, diameter E2 on emission surface 142 of light L emitted from light-emitting element 130 that is emitted from emission surface 142 means the diameter of the irradiation spot of light emitted from the light-emitting surface of light-emitting element 130 that has reached emission surface 142.

Preferably, the following Equation 3, more preferably Equation 3A, is satisfied, where E1 is the diameter on incidence surface 141 of light L emitted from light-emitting element 130 that impinges on incidence surface 141, and E2 is the diameter on emission surface 142 of light L emitted from light-emitting element 130 that is emitted from emission surface 142.

$$E 1 / E 2 > 1.2 \qquad ( Equation 3 )$$

$$E 1 / E 2 > 4. \qquad ( Equation 3 A )$$

When diameter E1 on incidence surface 141 of light L emitted from light-emitting element 130 that impinges on incidence surface 141 and diameter E2 on emission surface 142 of light L emitted from light-emitting element 130 that is emitted from emission surface 142 satisfy the relationship described above, a small curvature radius can be selected for the shape of the optical surface of emission surface 142. As a result, the distance between emission surface 142 and the end surface of transmission body 120 can be set small. In the present embodiment, E1/E2 is 5.080.

Preferably, the following Equation 4, more preferably Equation 4A, is satisfied, where D1 is the distance between the light-emitting surface of light-emitting element 130 and the center of incidence surface 141, and D2 is the distance between the center of emission surface 142 and the end surface of optical transmission member 120.

$$D 1 / D 2 > 5 \qquad ( Equation 4 )$$

$$D 1 / D 2 > 9 \qquad ( Equation 4 A )$$

When distance D1 between the light-emitting surface of light-emitting element 130 and the center of incidence surface 141 and distance D2 between the center of emission surface 142 and the end surface of optical transmission member 120 satisfy the relationship described above, the influence of the positional displacement of the focal point between the center of emission surface 142 and the end surface of optical transmission member 120 on the positional displacement between the light-emitting surface of light-emitting element 130 and the center of incidence surface 141 can be suppressed. In addition, it is possible to reduce the influence of a change of D2 due to a change of light (beam) incident on the emission surface and a change of D1. In the present embodiment, D1/D2 is 23.669. Note that D2/D1 is 0.042.

Light paths of light L emitted from light-emitting element 130 in transmission apparatus 100 of the present embodiment were simulated. In addition, for comparison, light paths of light L emitted from light-emitting element 130 in a transmission apparatus provided with a known planoconvex lens were also simulated.

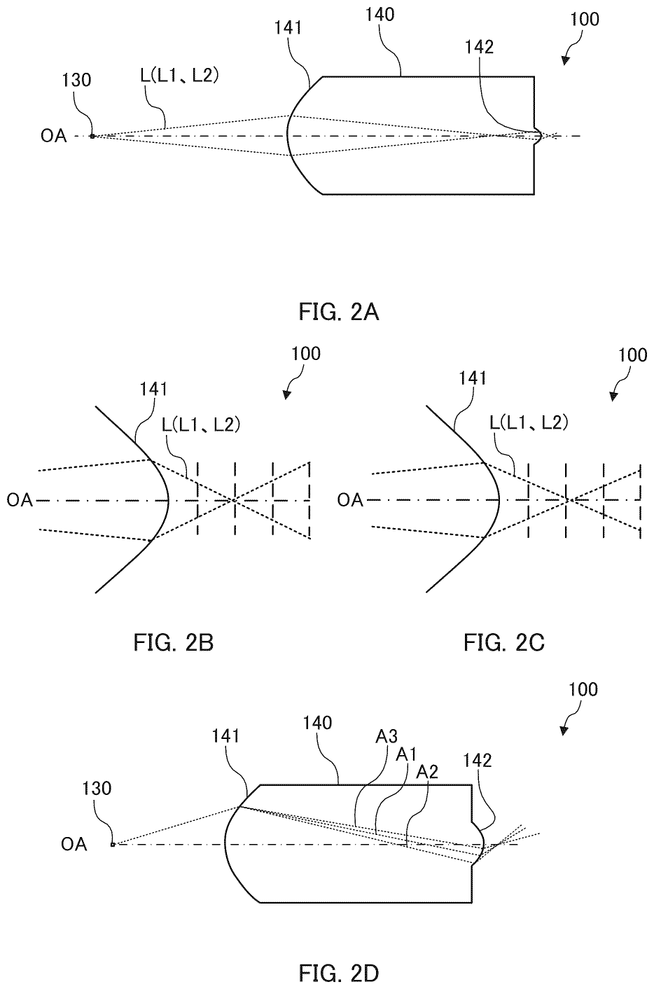

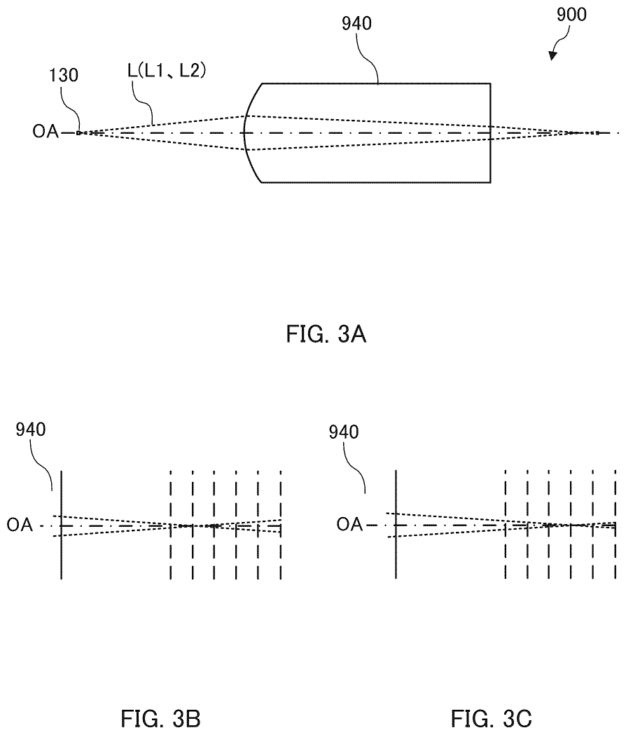

FIG. 2A is a diagram illustrating light paths in the state where transmission apparatus 100 of the present embodiment is in a standard state (normal temperature), FIG. 2B is a diagram illustrating light paths in the region around the focal point in the case where the refractive index is set to a high state, FIG. 2C is a diagram illustrating light paths in the region around the focal point in the case where the refractive index is set to a low state, and FIG. 2D is a schematic view for describing effects of the present invention. FIG. 3A is a diagram illustrating light paths in a transmission apparatus of a comparative example in a standard state (normal temperature), FIG. 3B is a diagram illustrating light paths in the region around the focal point in the case where the refractive index is set to a high state, and FIG. 3C is a diagram illustrating light paths in the region around the focal point in the case where the refractive index is set to a low state. Note that in FIGS. 2B, 2C, 3B and 3C, optical transmission member 120 is omitted to illustrate the position of the focal point.

As illustrated in FIGS. 2A to 2C, in transmission apparatus 100 of the present embodiment, the positional change of the focal point in optical receptacle 140 can be suppressed regardless of whether the refractive index is set to a high state or the refractive index is set to a low state in the cross section including optical axis OA of light-emitting element 130, the center of incidence surface 141 and the center of emission surface 142. More specifically, a part of light L emitted from light-emitting element 130 enters optical receptacle 140 from incidence surface 141. Light L having entered optical receptacle 140 intersects optical axis OA in the region between incidence surface 141 and emission surface 142 (inside optical receptacle 140). In the present embodiment, in the cross section including optical axis OA (the example illustrated in FIG. 2A), light L that impinges on incidence surface 141 from one side (e.g., the upper side) with respect to optical axis OA reaches emission surface 142 on the other side (e.g., the lower side) with respect to optical axis OA. Light L having reached emission surface 142 is focused toward the light focal position. As illustrated in FIGS. 2B and 2C, in the present embodiment, the light focal position does not change much regardless of whether the refractive index is set to a high state or the refractive index is set to a low state. In the present embodiment, the difference between the position of the focal point of the case with a low refractive index and the position of the focal point of the case with a high refractive index is 0.00142 mm.

As illustrated in FIG. 2D, the refractive index of resin optical receptacle 140 changes in response to a change in environmental temperature and the like. For example, in the case of the standard state (normal temperature), light A1 emitted from light-emitting element 130 impinges on incidence surface 141 so as to be emitted from emission surface 142.

When the environmental temperature is set to a low temperature, the refractive index increases in comparison with the standard state (normal temperature). In this case, light A2 emitted from light-emitting element 130 is largely refracted at incidence surface 141 on the basis of the Snell's law in comparison with the case of the standard state (normal temperature). Light A2 having entered from incidence surface 141 travels inside optical receptacle 140 toward optical axis OA. Light A2 having travelled through optical receptacle 140 is largely refracted at emission surface 142 on the basis of Snell's law in comparison with the case of the standard state (normal temperature) after intersecting optical axis OA. In the case where the refractive index is increased to a large refractive index, light A2 having travelled through optical receptacle 140 is emitted from the outer side with respect to optical axis OA in comparison with the emission position at emission surface 142 of light A1 having travelled through optical receptacle 140 in the case of the standard state (normal temperature). As a result, light A2 having travelled through optical receptacle 140 is largely refracted at emission surface 142 in comparison with the case of the standard state (normal temperature). Light A2 emitted from emission surface 142 intersects optical axis OA at substantially the same position as light A1 at normal temperature. Thus, the light intersects optical axis OA at substantially the same position regardless of whether the refractive index is changed or is in the standard state (normal temperature).

On the other hand, when the environmental temperature is set to a high temperature, the refractive index decreases in comparison with the standard state (normal temperature). In this case, light A3 emitted from light-emitting element 130 is slightly refracted at incidence surface 141 in comparison with the case of the standard state (normal temperature) on the basis of Snell's law. Light A3 having entered from incidence surface 141 travels inside optical receptacle 140 toward optical axis OA. Light A3 having travelled through optical receptacle 140 is slightly refracted at emission surface 142 in comparison with the case of the standard state (normal temperature) on the basis of Snell's law. When the refractive index decreases to a small refractive index, light A2 having travelled through optical receptacle 140 is emitted from the inner side with respect to optical axis OA in comparison with the emission position at emission surface 142 of light A1 having travelled through optical receptacle 140 in the case of the standard state (normal temperature). In the present embodiment, the curvature at emission surface 142 increases toward the outside of emission surface 142. As a result, light A3 having travelled through optical receptacle 140 is slightly refracted at emission surface 142 in comparison with the case of the standard state (normal temperature). Light A3 emitted from emission surface 142 intersects optical axis OA at substantially the same position as light A1 in the case of the standard state (normal temperature). Thus, the light intersects optical axis OA at substantially the same position regardless of whether the refractive index is changed or is in the standard state (normal temperature).

In this manner, the positional displacement of the focal point can be suppressed even when the refractive index is changed.

On the other hand, as illustrated in FIGS. 3A to 3C, in transmission apparatus 900 of the comparative example including planoconvex lens 940, the light focal position changes depending on the temperature used. In the present embodiment, the difference between the position of the focal point at a low temperature and the position of the focal point at a high temperature is 0.035 mm. Note that the focal length at normal temperature in the standard state (normal temperature) is 0.58 mm.

### Effects

In this manner, transmission apparatus 100 of Embodiment 1 satisfies R1/R2|>1.5 and T/(R1+R2) >1.2, where R1 is the curvature radius of the center of incidence surface 141, R2 is the curvature radius of the center of emission surface 142, and T is the light path length between the center of incidence surface 141 and the center of emission surface 142, and thus can suppress the positional displacement of the focal point regardless of the use environment.

### Other Example (1) of Embodiment 1

Next, transmission apparatus 200 of other example (1) of Embodiment 1 is described. Transmission apparatus 200 of other example (1) of Embodiment 1 is different from transmission apparatus 100 of Embodiment 1 in that light L having entered from incidence surface 241 intersects optical axis OA on the incidence surface 241 side than in Embodiment 1. In view of this, optical receptacle 240 is mainly described below.

### Configuration of Transmission Apparatus

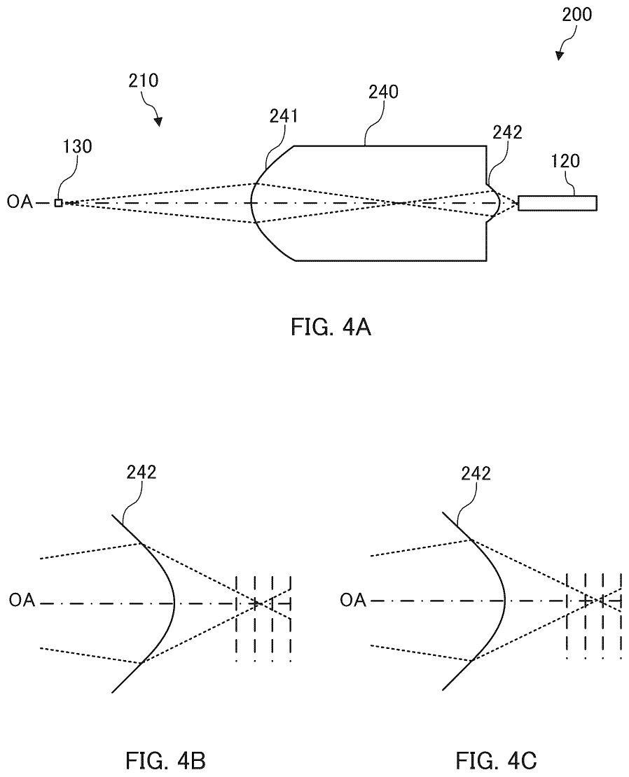

FIG. 4A is a diagram illustrating light paths in transmission apparatus 200 of other example (1) of Embodiment 1 in the standard state (normal temperature), FIG. 4B is a diagram illustrating light paths in the region around the focal point in the case where the refractive index is set to a high state, and FIG. 4C is a diagram illustrating light paths in the region around the focal point in the case where the refractive index is set to a low state. Note that in FIGS. 4B and 4C, optical transmission member 120 is omitted to illustrate the position of the focal point.

As illustrated in FIG. 4A, transmission apparatus 200 includes optical module 210 and optical transmission member 120. Optical module 210 includes light-emitting element 130 and optical receptacle 240. Light-emitting element 130 and optical transmission member 120 are the same as those of Embodiment 1, and therefore the description thereof will be omitted.

Optical receptacle 240 is a resin biconvex lens disposed between light-emitting element 130 and optical transmission member 120. Optical receptacle 240 may be manufactured by being integrally molded through injection molding, for example. Optical receptacle 240 includes incidence surface 241 and emission surface 242. The central axis of incidence surface 241 and the central axis of emission surface 242 coincide with each other.

In other example (1) of Embodiment 1, curvature radius R1 of the center of incidence surface 241 is 0.2 mm. In addition, diameter E1 on incidence surface 241 of light L emitted from light-emitting element 130 that impinges on incidence surface 241 is 0.205 mm. In addition, the distance between the light-emitting surface of light-emitting element 130 and the center of incidence surface 241 is 1.0 mm.

Light L having entered from incidence surface 241 travels toward emission surface 242. In other example (1) of Embodiment 1, in the cross section including optical axis OA of light-emitting element 130, the center of incidence surface 241 and the center of emission surface 242, light L emitted at the center of the light-emitting surface of light-emitting element 130 includes light that intersects optical axis OA in the region between incidence surface 241 and emission surface 242.

In other example (1) of Embodiment 1, curvature radius R2 of the center of emission surface 242 is −0.05 mm. The distance between the center of emission surface 242 and the center of the end surface of optical transmission member 120 is 0.106 mm. Diameter E2 on emission surface 242 of light emitted from light-emitting element 130 that is emitted from emission surface 242 is 0.065 mm.

R1/R2| is 4.00. Note that |R2|/R1 is 0.25. T/(R1+R2) is 5.200. Light path length T between the center of incidence surface 241 and the center of emission surface 242 is 1.3 mm. E1/E2 is 1.58. D1/D2 is 9.447. Note that D2/D1 is 0.106.

Now light paths of light L emitted from light-emitting element 130 in transmission apparatus 200 of other example (1) of Embodiment 1 are described below.

As illustrated in FIGS. 4A to 4C, transmission apparatus 200 of other example (1) of Embodiment 1 can suppress the displacement of the light focal position in optical receptacle 200 regardless of whether the refractive index is set to a high state or the refractive index is set to a low state. More specifically, light L emitted from light-emitting element 130 enters optical receptacle 240 from incidence surface 241. Light L having entered optical receptacle 240 intersects optical axis OA in the region between incidence surface 141 and emission surface 242 (inside optical receptacle 240). In the present embodiment, in the cross section including optical axis OA (the example illustrated in FIG. 4A), light L that impinges on incidence surface 241 from one side with respect to optical axis OA reaches emission surface 242 on the other side with respect to optical axis OA. The light having reached emission surface 242 is focused toward the light focal position. Note that curvature radius R1 of the center of incidence surface 241 is greater than curvature radius R1 of the center of incidence surface 241 in Embodiment 1, and therefore light L having entered from incidence surface 241 intersects optical axis OA on the incidence surface 241 side than in Embodiment 1. As illustrated in FIGS. 4B and 4C, the position of the focal point does not change much regardless of whether the refractive index is set to a high state or the refractive index is set to a low state. The difference between the position of the focal point of the case where the refractive index is set to a low state and the position of the focal point of the case where the refractive index is set to a high state is 0.00197 mm. Note that the focal length in the standard state (normal temperature) is −0.06 mm.

### Effects

In this manner, transmission apparatus 200 of the present embodiment has the same effect as that of Embodiment 1.

### Other Example (2) of Embodiment 1

Next, transmission apparatus 300 of other example (2) of Embodiment 1 is described. Transmission apparatus 300 of other example (2) of Embodiment 1 is different from transmission apparatus 100 of Embodiment 1 in that incident light L having entered from incidence surface 341 intersects optical axis OA on incidence surface 341 side than in Embodiment 1. In view of this, optical receptacle 340 is mainly described below.

### Configuration of Transmission Apparatus

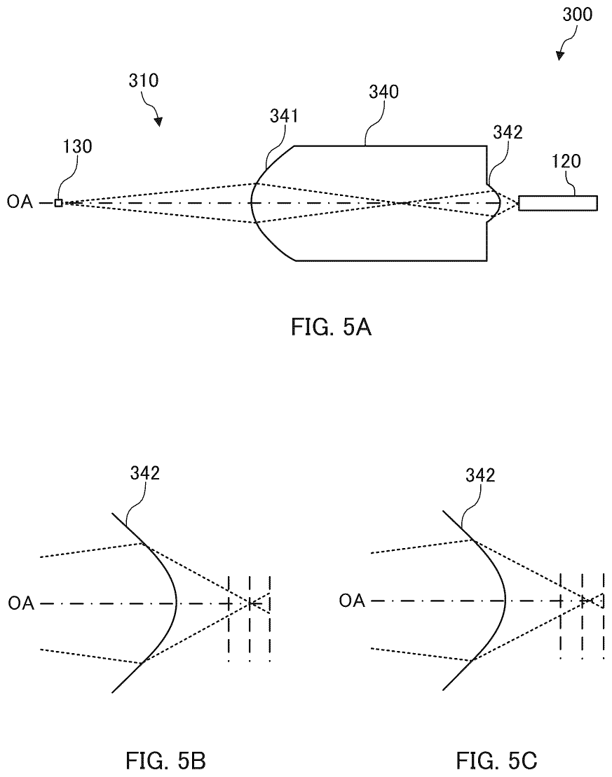

FIG. 5A is a diagram illustrating light paths in transmission apparatus 300 of other example (2) of Embodiment 1 in the standard state (normal temperature), FIG. 5B is a diagram illustrating light paths in the region around the focal point in the case where the refractive index is set to a high state, and FIG. 5C is a diagram illustrating light paths in the region around the focal point in the case where the refractive index is set to a low state. Note that in FIGS. 5B and 5C, optical transmission member 120 is omitted to illustrate the position of the focal point.

As illustrated in FIG. 5A, transmission apparatus 300 includes optical module 310 and optical transmission member 120. Optical module 310 includes light-emitting element 130 and optical receptacle 340. Light-emitting element 130 and optical transmission member 120 are the same as those of Embodiment 1, and therefore the description thereof will be omitted.

Optical receptacle 340 is a resin biconvex lens disposed between light-emitting element 130 and optical transmission member 120. Optical receptacle 340 may be manufactured by being integrally molded through injection molding, for example. Optical receptacle 340 includes incidence surface 341 and emission surface 342. The central axis of incidence surface 341 and the central axis of emission surface 342 coincide with each other.

In the present embodiment, curvature radius R1 of the center of incidence surface 341 is 0.2 mm. Diameter E1 on incidence surface 341 of light emitted from light-emitting element 130 that impinges on incidence surface 341 is 0.205 mm. The distance between the light-emitting surface of light-emitting element 130 and the center of incidence surface 341 is 1.0 mm.

Light L having entered from incidence surface 341 travels toward emission surface 342. Also in the present embodiment, in the cross section including optical axis OA of light-emitting element 130, the center of incidence surface 341 and the center of emission surface 342, light L emitted at the center of the light-emitting surface of light-emitting element 130 intersects optical axis OA in the region between incidence surface 341 and emission surface 342.

In other example (2) of Embodiment 1, curvature radius R2 of the center of incidence surface 341 is −0.04 mm. The distance between the center of emission surface 342 and the center of the end surface of optical transmission member 120 is 0.080 mm. Diameter E2 on emission surface 342 of light L emitted from light-emitting element 130 that is emitted from emission surface 342 is 0.129 mm. R1/R2| is 5.00. Note that |R2|/R1 is 0.200. T/(R1+R2) is 5.417. In addition, light path length T between the center of incidence surface 341 and the center of emission surface 342 is 1.3 mm. E1/E2 is 1.588. D1/D2 is 12.569. Note that D2/D1 is 0.080.

Now light paths of light L emitted from light-emitting element 130 in transmission apparatus 300 of other example (2) of Embodiment 1 are described below.

As illustrated in FIGS. 5A to 5C, transmission apparatus 300 of other example (2) of Embodiment 1 can suppress the displacement of the light focal position in optical receptacle 340 regardless of whether the refractive index is set to a high state or the refractive index is set to a low state. More specifically, light emitted from light-emitting element 130 enters optical receptacle 340 from incidence surface 341. Light L having entered from optical receptacle 340 intersects optical axis OA inside optical receptacle 340. In other example (2) of Embodiment 1, in the cross section including optical axis OA (the example illustrated in FIG. 5A), light L that impinges on incidence surface 342 from one side with respect to optical axis OA reaches emission surface 342 on the other side with respect to optical axis OA. Light L having reached emission surface 342 is focused toward the light focal position. As illustrated in FIGS. 5B and 5C, in other example (2) of Embodiment 1, the position of the focal point does not change much regardless of whether the refractive index is set to a high state or the refractive index is set to a low state. In other example (2) of Embodiment 1, the difference between the position of the focal point of the case where the refractive index is set to a low state and the position of the focal point of the case where the refractive index is set to a high state is 0.00133 mm. Note that the focal length in the standard state (normal temperature) is −0.05 mm.

### Effects

In this manner, transmission apparatus 300 of the present embodiment has the same effect as that of Embodiment 1.

### Other Example (3) of Embodiment 1

Next, transmission apparatus 400 of other example (3) of Embodiment 1 is described. Transmission apparatus 400 of other example (3) of Embodiment 1 is different from transmission apparatus 100 of Embodiment 1 in that light L having entered from incidence surface 241 intersects optical axis OA on incidence surface 441 side than in Embodiment 1. In view of this, optical receptacle 440 is mainly described below.

### Configuration of Transmission Apparatus

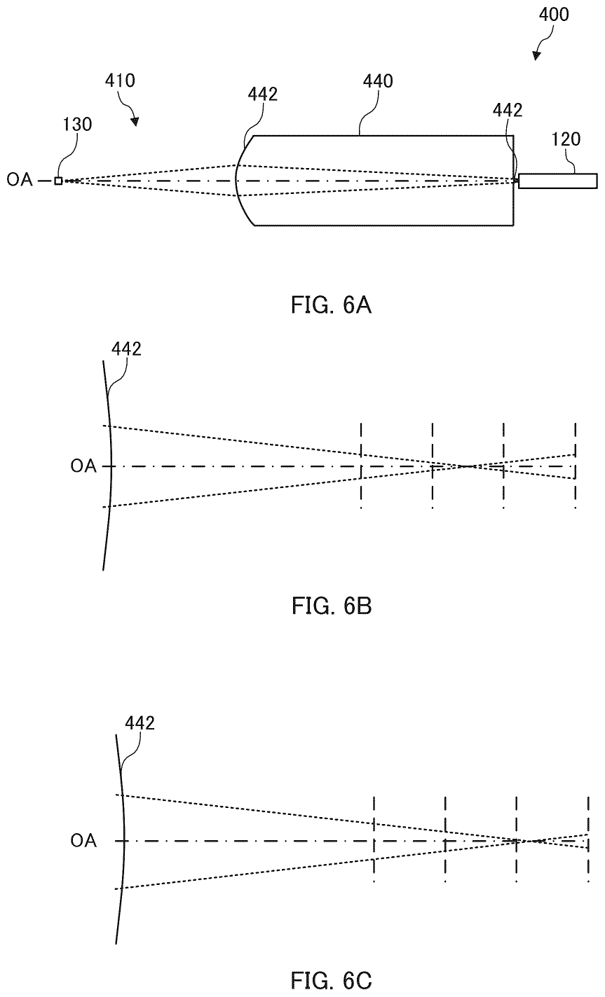

FIG. 6A is a diagram illustrating light paths in transmission apparatus 400 of other example (3) of Embodiment 1 in the standard state (normal temperature), FIG. 6B is a diagram illustrating light paths in the region around the focal point in the case where the refractive index is set to a high state, and FIG. 6C is a diagram illustrating light paths in the region around the focal point in the case where the refractive index is set to a low state. Note that in FIGS. 6B and 6C, optical transmission member 120 is omitted to illustrate the position of the focal point.

As illustrated in FIG. 6A, transmission apparatus 400 includes optical module 410 and optical transmission member 120. Optical module 410 includes light-emitting element 130 and optical receptacle 440. Light-emitting element 130 and optical transmission member 120 are the same as those of Embodiment 1, and therefore the description thereof will be omitted.

Optical receptacle 440 is a resin biconvex lens disposed between light-emitting element 130 and optical transmission member 120. Optical receptacle 440 may be manufactured by being integrally molded through injection molding, for example. Optical receptacle 440 includes incidence surface 441 and emission surface 442. The central axis of incidence surface 441 and the central axis of emission surface 442 coincide with each other.

In other example (3) of Embodiment 1, curvature radius R1 of the center of incidence surface 441 is 0.182 mm. Diameter E1 on incidence surface 541 of light L emitted from light-emitting element 130 that impinges on incidence surface 441 is 0.103 mm. The distance between the light-emitting surface of light-emitting element 130 and the center of incidence surface 441 is 1.0 mm.

Light having entered from incidence surface 441 travels toward emission surface 442. In other example (3) of Embodiment 1, in the cross section including optical axis OA of light-emitting element 130, the center of incidence surface 441 and the center of emission surface 442, light L emitted at the center of the light-emitting surface of light-emitting element 130 intersects optical axis OA in region between incidence surface 441 and emission surface 442.

In other example (3) of Embodiment 1, curvature radius R2 of the center of emission surface 442 is −0.077 mm. The distance between the center of emission surface 442 and the center of the end surface of optical transmission member 120 is 0.180 mm. Diameter E2 on emission surface 442 of light L emitted from light-emitting element 130 that is emitted from emission surface 442 is 0.152 mm. R1/R2| is 2.364. Note that |R2|/R1 is 0.423. T/(R1+R2) is 5.024. In addition, light path length T between the center of incidence surface 441 and the center of emission surface 442 is 1.3 mm. E1/E2 is 1.356. D1/D2 is 5.549. Note that D2/D1 is 0.180.

Now light paths of light L emitted from light-emitting element 130 in transmission apparatus 400 of other example (3) of Embodiment 1 are described below.

As illustrated in FIGS. 6A to 6C, transmission apparatus 400 of other example (3) of Embodiment 1 can suppress the displacement of the light focal position in optical receptacle 440 regardless of whether the refractive index is set to a high state or the refractive index is set to a low state. More specifically, light emitted from light-emitting element 130 enters optical receptacle 440 from incidence surface 441. Light having entered optical receptacle 440 intersects the optical axis inside optical receptacle 440. In other example (3) of Embodiment 1, in the cross section including optical axis OA (the example illustrated in FIG. 6A), the light that impinges on incidence surface 541 from one side with respect to optical axis OA reaches emission surface 442 on the other side with respect to optical axis OA. Light L having reached emission surface 542 is focused toward the light focal position. As illustrated in FIGS. 6B and 6C, in other example (3) of Embodiment 1, the position of the focal point does not change much regardless of whether the refractive index is set to a high state or the refractive index is set to a low state. In other example (3) of Embodiment 1, the difference between the position of the focal point of the case where the refractive index is set to a low state and the position of the focal point of the case where the refractive index is set to a high state is 0.00352 mm. Note that the focal length in the standard state (normal temperature) is −0.09 mm.

Simulations

Simulations were performed for the optical receptacle of the above-described other example (3) of Embodiment 1 and an optical receptacle of a comparative example by shifting the position of the light-emitting element in the Y direction, shifting the position of the end surface of the optical transmission member in the Z direction, and changing the refractive index of the optical receptacle.

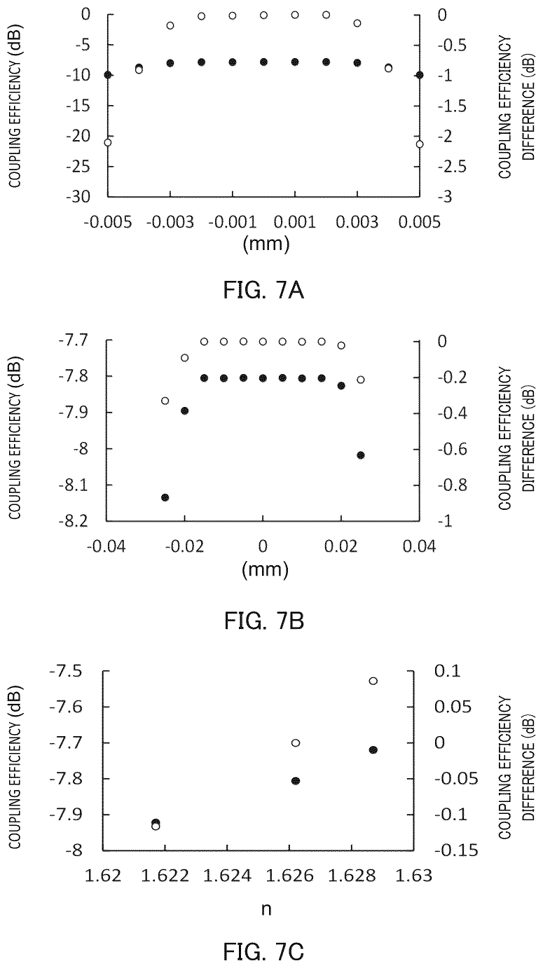

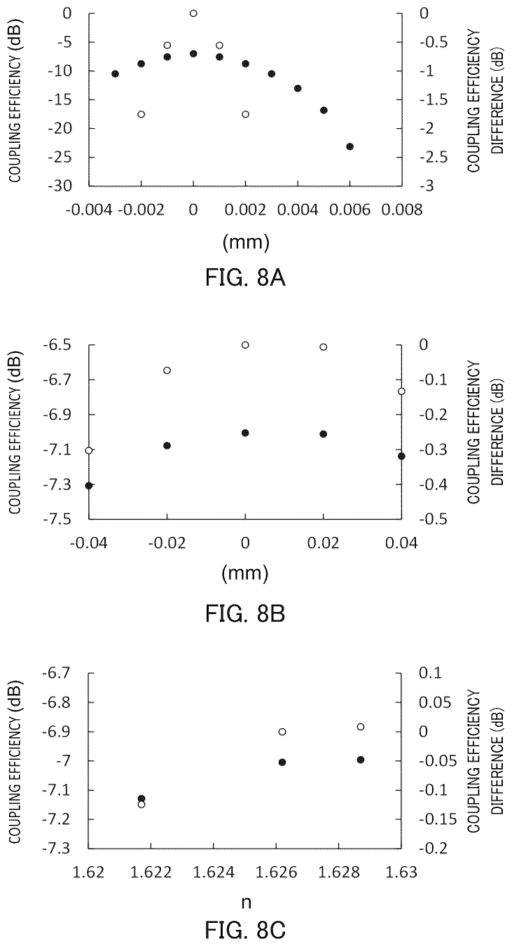

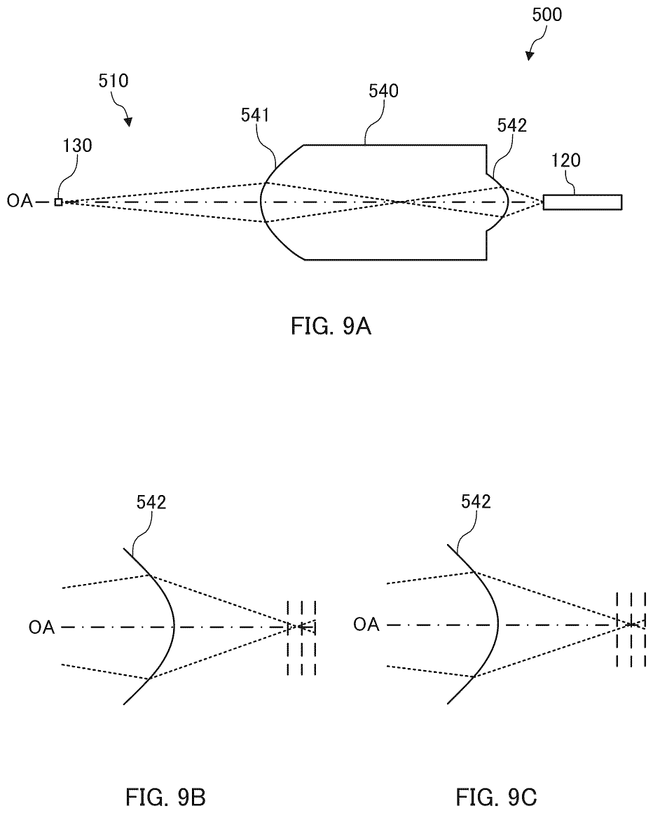

FIGS. 7A to 7C are graphs showing results of the optical receptacle of other example (3) of Embodiment 1, and FIGS. 8A to 8C are graphs showing results of the optical receptacle of the comparative example (the planoconvex lens illustrated in FIG. 3). FIG. 7A is a graph showing results obtained by shifting the position of the light-emitting element in the Y direction, FIG. 7B is a graph showing results obtained by shifting the position of the end surface of optical transmission member in the Z direction, and FIG. 7C is a graph showing results obtained by changing the refractive index of the optical receptacle. FIG. 8A is a graph showing results obtained by shifting the position of the light-emitting element in the Y direction, FIG. 8B is a graph showing results obtained by shifting the position of the end surface of optical transmission member in the Z direction, and FIG. 8C is a graph showing results obtained by changing the refractive index of the optical receptacle. In FIGS. 7A to 8C, the black circle represents the coupling efficiency (the first axis on the left side), and the white circle represents the coupling efficiency difference (the first axis on the right side). Note that the coupling efficiency means the light coupling efficiency between the light-emitting element and the optical transmission member. In addition, the coupling efficiency difference means the difference from the coupling efficiency of the case where the shift of the light-emitting element or the light coupling efficiency is 0 mm.

As illustrated in FIGS. 7A to 8C, in the case where the optical receptacle of other example (3) of Embodiment 1 is used, the light coupling efficiency is less reduced in comparison with the case where the optical receptacle of the comparative example is used even when there is a positional displacement of the light-emitting element. In the case where the optical receptacle of other example (3) of Embodiment 1 is used, it is possible to suppress the displacement of the light focal position in the optical receptacle regardless of whether the refractive index is set to a high state or the refractive index is set to a low state. In addition, the reduction in coupling efficiency can be suppressed even in the case where optical transmission member is shifted in the Y direction.

### Effects

In this manner, transmission apparatus 400 of the present embodiment has the same effect as that of Embodiment 1.

### Embodiment 2

Next, transmission apparatus 500 of Embodiment 2 is described. Transmission apparatus 500 of the present embodiment is different from transmission apparatus 100 of

Embodiment 1 in that light does not intersect optical axis OA in the region between incidence surface 541 and emission surface 542. In view of this, optical receptacle 540 is mainly described below.

### Configuration of Transmission Apparatus

FIG. 9A is a diagram illustrating light paths in transmission apparatus 500 of Embodiment 2 in the standard state (normal temperature), FIG. 9B is a diagram illustrating light paths in the region around the focal point in the case where the refractive index is set to a high state, and FIG. 9C is a diagram illustrating light paths in the region around the focal point in the case where the refractive index is set to a low state. Note that in FIGS. 9B and 9C, optical transmission member 120 is omitted to illustrate the position of the focal point.

As illustrated in FIG. 9A, transmission apparatus 500 includes optical module 510 and optical transmission member 120. Optical module 510 includes light-emitting element 130 and optical receptacle 540. Light-emitting element 130 and optical transmission member 120 are the same as those of Embodiment 1, and therefore the description thereof will be omitted.

Optical receptacle 540 is a resin biconvex lens disposed between light-emitting element 130 and optical transmission member 120. Optical receptacle 540 may be manufactured by being integrally molded through injection molding, for example. Optical receptacle 540 includes incidence surface 541 and emission surface 542. The central axis of incidence surface 541 and the central axis of emission surface 542 coincide with each other.

In the present embodiment, curvature radius R1 of the center of incidence surface 541 is 0.375 mm. Diameter E1 on incidence surface 541 of light emitted from light-emitting element 130 is 0.202 mm. The distance between the light-emitting surface of light-emitting element 130 and the center of incidence surface 541 is 1.125 mm.

The light having entered from incidence surface 541 travels toward emission surface 542. In the present embodiment, in the cross section including optical axis OA of light-emitting element 130, the curvature radius of incidence surface 541 is small, and therefore the incidence position on incidence surface 541 of light L emitted from the center of the light-emitting surface of light-emitting element 130, and the incidence position on emission surface 542 of light L are positions on the same side with respect to optical axis OA. That is, in the present embodiment, incident light L having entered from incidence surface 541 does not intersect optical axis OA inside optical receptacle 540.

In the present embodiment, curvature radius R2 of the center of emission surface 542 is −0.235 mm. The distance between the center of emission surface 542 and the center of the end surface of optical transmission member 120 is 0.091 mm. Diameter E2 on emission surface 542 of light L emitted from light-emitting element 130 is 0.021 mm.

Preferably, transmission apparatus 500 satisfies the following Equation 1, more preferably Equation 1A, where R1 is the curvature radius of the center of incidence surface 541, and R2 is the curvature radius of the center of emission surface 542.

$$R 1 / \vert R 2 \vert > 1.5 \qquad ( Equation 1 )$$

$$R 1 / \vert R 2 \vert > 3.5 \qquad ( Equation 1 A )$$

In the present embodiment, R1/R2| is 1.595. Note that |R2|/R1 is 0.627.

In addition, preferably, transmission apparatus 500 satisfies the following Equation 2, more preferably Equation 2A, where R1 is the curvature radius of the center of incidence surface 541, R2 is the curvature radius of the center of emission surface 542, and T is the light path length between the center of incidence surface 541 and the center of emission surface 542.

$$T / ( R 1 + R 2 ) > 1.5 \qquad ( Equation 2 )$$

$$T / ( R 1 + R 2 ) > 4 \qquad ( Equation 2 A )$$

In the present embodiment, T/(R1+R2) is 3.112. In addition, in the present embodiment, light path length T between the center of incidence surface 541 and the center of emission surface 542 is 1.9 mm.

It is preferable to satisfy the following Equation 3, more preferably Equation 3A, where E1 is the diameter on incidence surface 541 of light L emitted from light-emitting element 130 that enters from incidence surface 541, and E2 is the diameter on emission surface 542 of light L emitted from light-emitting element 130 that is emitted from emission surface 542.

$$E 1 / E 2 > 1.2 \qquad ( Equation 3 )$$

$$E 1 / E 2 > 4. \qquad ( Equation 3 A )$$

In the present embodiment, E1/E2 is 9.73.

It is preferable to satisfy the following Equation 4, more preferably Equation 4A, where D1 is the distance between the light-emitting surface of light-emitting element 130 and incidence surface 541, and D2 is the distance between emission surface 542 and the end surface of optical transmission member 120.

$$D 1 / D 2 > 5 \qquad ( Equation 4 )$$

$$D 1 / D 2 > 9 \qquad ( Equation 4 A )$$

In the present embodiment, D1/D2 is 12.310. Note that D2/D1 is 0.081.

Now light paths of light L emitted from light-emitting element 130 in transmission apparatus 500 of the present embodiment are described below.

As illustrated in FIGS. 9A to 9C, transmission apparatus 500 of the present embodiment can suppress the positional displacement of the focal point in optical receptacle 540 regardless of whether the refractive index is set to a high state or the refractive index is set to a low state. More specifically, light L emitted from light-emitting element 130 enters optical receptacle 540 from incidence surface 541. Light L having entered optical receptacle 540 does not intersect optical axis OA inside optical receptacle 540. In the present embodiment, in the cross section including optical axis OA (the example illustrated in FIG. 8A), light L that impinges on the incidence surface from one side with respect to optical axis OA reaches emission surface 542 on the same side. Light L having reached emission surface 542 is focused toward the light focal position. As illustrated in FIGS. 8B and 8C, in the present embodiment, the position of the focal point does not change much regardless of whether the refractive index is set to a high state or the refractive index is set to a low state. In the present embodiment, the difference between the position of the focal point of the case where the refractive index is set to a high state, and the position of the focal point of the case where the refractive index is set to a high state is 0.01555 mm. Note that the focal length in the standard state (normal temperature) is −1.181 mm.

### Effects

In this manner, transmission apparatus 500 of the present embodiment has the same effect as that of Embodiment 1.

### Embodiment 3

Next, transmission apparatus 600 of Embodiment 3 is described. Transmission apparatus 600 of the present embodiment is different from transmission apparatus 100 of Embodiment 1 in that light does not intersect optical axis OA in the region between incidence surface 641 and emission surface 642. In view of this, optical receptacle 640 is mainly described below.

### Configuration of Transmission Apparatus

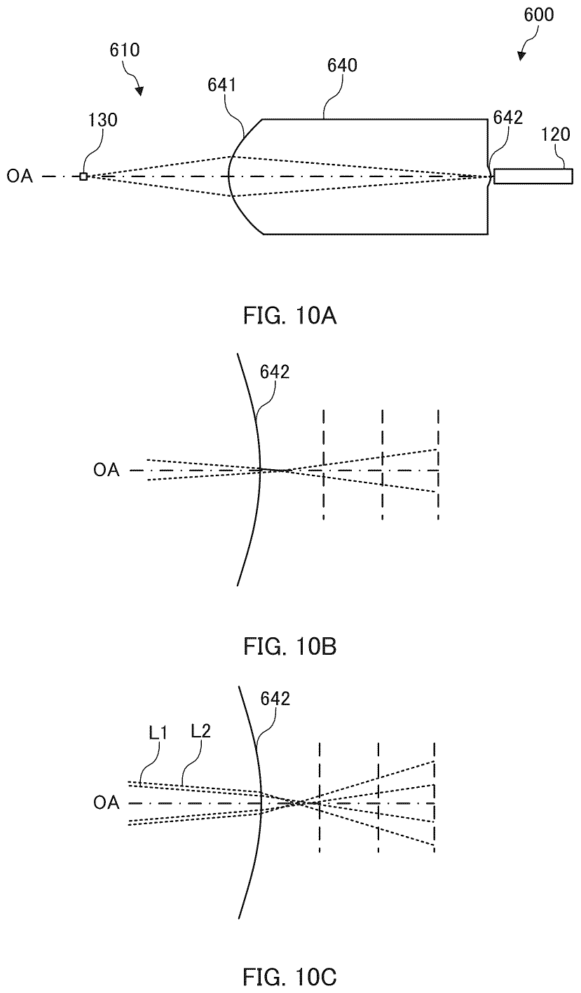

FIG. 10A is a diagram illustrating light paths in transmission apparatus 600 of Embodiment 3 in the standard state (normal temperature), FIG. 10B is a diagram illustrating light paths in the region around the focal point in the case where the refractive index is set to a high state, and FIG. 10C is a diagram illustrating light paths in the region around the focal point in the case where the refractive index is set to a low state. Note that in FIGS. 10B and 10C, optical transmission member 120 is omitted to illustrate the position of the focal point.

As illustrated in FIG. 10A, transmission apparatus 600 includes optical module 610 and optical transmission member 120. Optical module 610 includes light-emitting element 130 and optical receptacle 640. Light-emitting element 130 and optical transmission member 120 are the same as those of Embodiment 1, and therefore the description thereof will be omitted.

Optical receptacle 640 is a resin biconvex lens disposed between light-emitting element 130 and optical transmission member 120. Optical receptacle 640 may be manufactured by being integrally molded through injection molding, for example. Optical receptacle 640 includes incidence surface 641 and emission surface 642. The central axis of incidence surface 641 and the central axis of emission surface 642 coincide with each other.

In the present embodiment, curvature radius R1 of the center of incidence surface 641 is 0.25 mm. In the present embodiment, diameter E1 on incidence surface 641 of light L emitted from light-emitting element 130 that impinges on incidence surface 641 is 0.204 mm. In the present embodiment, the distance between the light-emitting surface of light-emitting element 130 and the center of incidence surface 641 is 1.35 mm.

Light having entered from incidence surface 641 travels toward emission surface 642. In the present embodiment, in the cross section including optical axis OA of light-emitting element 130, the center of incidence surface 641 and the center of emission surface 642, light L emitted at the center of the light-emitting surface of light-emitting element 130 does not intersect optical axis OA in the region between incidence surface 641 and emission surface 642.

In the present embodiment, curvature radius R2 of the center of emission surface 642 is −0.667 mm. In the present embodiment, the distance between the center of emission surface 642 and the center of the end surface of optical transmission member 120 is 0.026 mm. In the present embodiment, diameter E2 on emission surface 642 of light emitted from light-emitting element 130 that is emitted from emission surface 642 is 0.004 mm.

Note that in the present embodiment, with the relationship between the curvature radius of incidence surface 641 and the curvature radius of emission surface 642, the second position is closer to emission surface 642 than the first position. The first position is a position where first light beam L1 emitted from emission surface 642 intersects optical axis OA of light-emitting element 130. The second position is a position where second light beam L2 emitted toward the outside of incidence surface 641 than first light beam L1 that enters from incidence surface 641 so as to be emitted from emission surface 642 intersects optical axis OA.

Preferably, transmission apparatus 600 satisfies the following Equation 1, more preferably Equation 1A, where R1 is the curvature radius of the center of incidence surface 641, and R2 is the curvature radius of the center of emission surface 642.

$$R 1 / \vert R 2 \vert > 1.5 \qquad ( Equation 1 )$$

$$R 1 / \vert R 2 \vert > 3.5 \qquad ( Equation 1 A )$$

In the present embodiment, R1/R2| is 3.750. Note that |R2|/R1 is 0.267.

In addition, preferably, transmission apparatus 600 satisfies the following Equation 2, more preferably Equation 2A, where R1 is the curvature radius of the center of incidence surface 641, R2 is the curvature radius of the center of emission surface 642, and T is the light path length between the center of incidence surface 641 and the center of emission surface 642.

$$T / ( R 1 + R 2 ) > 1.5 \qquad ( Equation 2 )$$

$$T / ( R 1 + R 2 ) > 4 \qquad ( Equation 2 A )$$

In the present embodiment, T/(R1+R2) is 4.263. In addition, in the present embodiment, light path length T between the center of incidence surface 641 and the center of emission surface 642 is 1.35 mm.

It is preferable to satisfy the following Equation 3, more preferably Equation 3A, where E1 is the diameter on incidence surface 641 of light emitted from light-emitting element 130 that impinges on incidence surface 641, and E2 is the diameter on emission surface 642 of light emitted from light-emitting element 130 that is emitted from emission surface 642.

$$E 1 / E 2 > 1.2 \qquad ( Equation 3 )$$

$$E 1 / E 2 > 4. \qquad ( Equation 3 A )$$

In the present embodiment, E1/E2 is 46.455.

It is preferable to satisfy the following Equation 4, more preferably Equation 4A,

where D1 is the distance between the light-emitting surface of light-emitting element 130 and incidence surface 641, and D2 is the distance between emission surface 642 and the end surface of optical transmission member 120.

$$D 1 / D 2 > 5 \qquad ( Equation 4 )$$

$$D 1 / D 2 > 9 \qquad ( Equation 4 A )$$

In the present embodiment, D1/D2 is 28.654. Note that D2/D1 is 0.035.

Now light paths of light L emitted from light-emitting element 130 in transmission apparatus 600 of the present embodiment are described below.

As illustrated in FIGS. 10A to 10C, transmission apparatus 600 of the present embodiment can suppress the positional displacement of the focal point in optical receptacle 640 regardless of whether the refractive index is set to a high state or the refractive index is set to a low state. More specifically, light emitted from light-emitting element 130 enters optical receptacle 640 from incidence surface 641. Light having entered optical receptacle 640 does not intersect the optical axis inside optical receptacle 640. As illustrated in FIG. 10C, the second position is closer to emission surface 642 than the first position. The first position is the position where first light beam L1 emitted from the center of the light-emitting surface of light-emitting element 130 that impinges on incidence surface 641 and travels inside optical receptacle 640 so as to be emitted from emission surface 642 intersects optical axis OA of light-emitting element 130, and the second position is the position where second light beam L2 emitted from the center of the light-emitting surface of light-emitting element 130 and emitted toward the outside of incidence surface 641 than first light beam L1 that impinges on incidence surface 641 so as to be emitted from emission surface 642 intersects optical axis OA. In the present embodiment, the position of the focal point does not change much regardless of whether the refractive index is set to a high state or the refractive index is set to a low state. In the present embodiment, the difference between the position of the focal point of the case where the refractive index is set to a low state and the position of the focal point of the case where the refractive index is set to a high state is 0.011 mm. Note that the focal length of the case with no change in refractive index is −0.13 mm.

### Effects

In this manner, transmission apparatus 600 of the present embodiment has the same effect as that of Embodiment 1.

### Embodiment 4

### Configuration of Transmission Apparatus

Next, transmission apparatus 700 of Embodiment 4 is described. Transmission apparatus 700 of the present embodiment is different from transmission apparatus 100 of Embodiment 1 only in the configuration of optical receptacle 740. In view of this, optical receptacle 740 is mainly described below, and the same configurations are denoted with the same reference numerals, and, the description thereof will be omitted.

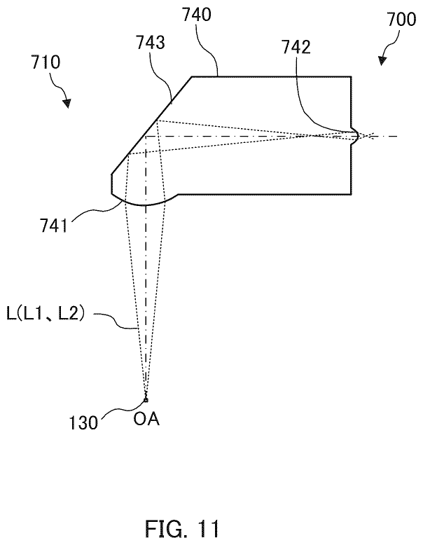

FIG. 11 is a diagram illustrating a configuration of transmission apparatus 700 of Embodiment 4.

As illustrated in FIG. 11, transmission apparatus 700 of the present embodiment includes optical module 710 and optical transmission member 120. Optical module 710 includes light-emitting element 130 and optical receptacle 740. Light-emitting element 130 and optical transmission member 120 are the same as those of Embodiment 1, and therefore the description thereof will be omitted.

Optical receptacle 740 is a resin biconvex lens disposed between light-emitting element 130 and optical transmission member 120. Optical receptacle 740 may be manufactured by being integrally molded through injection molding, for example. Optical receptacle 740 includes incidence surface 741, emission surface 742, and reflection surface 743.

Reflection surface 243 reflects toward emission surface 742 the light having entered from incidence surface 741. In the present embodiment, reflection surface 743 may be a flat surface or a convex surface. In the present embodiment, reflection surface 743 is a flat surface.

Although not illustrated in the drawings, transmission apparatus 700 of the present embodiment can suppress the positional displacement of the focal point in optical receptacle 740 regardless of whether the refractive index is set to a high state or the refractive index is set to a low state. More specifically, light emitted from light-emitting element 130 enters optical receptacle 740 from incidence surface 741. Light having entered optical receptacle 740 intersects optical axis OA inside optical receptacle 740. In the present embodiment, in the cross section including optical axis OA (the example illustrated in FIG. 11), light that impinges on incidence surface 741 from one side with respect to optical axis OA reaches emission surface 742 on the other side with respect to the central light beam of light reflected by reflection surface 743. The light having reached emission surface 742 is focused toward the focal point.

### Effects

In this manner, transmission apparatus 700 of the present embodiment has the same effect as that of Embodiment 1.

### INDUSTRIAL APPLICABILITY

The optical receptacle and the optical module of the present invention are suitable for optical communications using optical transmission members, for example.

### REFERENCE SIGNS LIST

100, 200, 300, 400, 500, 600, 700, 900 Transmission apparatus

110, 210, 310, 410, 510, 610, 710 Optical module

120 Optical transmission member

130 Light-emitting element

140, 240, 340, 440, 540, 640, 740, 940 Optical receptacle

141, 241, 341, 441, 541, 641, 741 Incidence surface

142, 242, 342, 424, 544, 642, 742 Emission surface

1. An optical receptacle made of resin and configured to optically couple a light-emitting element and an end surface of an optical transmission member when the optical receptacle is disposed between the light-emitting element and the optical transmission member, the optical receptacle comprising:
an incidence surface that is a convex surface configured to allow incidence of light emitted from the light-emitting element;
an emission surface that is a convex surface configured to emit, toward the end surface of the optical transmission member, light incident on the incidence surface,
wherein the following Equation 1 and Equation 2 are satisfied:
$$R 1 / \vert R 2 \vert > 1.5 , and \qquad ( Equation 1 )$$
$$T / ( R 1 + R 2 ) > 1.5 \qquad ( Equation 2 )$$
where R1 is a curvature radius of a center of the incidence surface, R2 is a curvature radius of a center of the emission surface, and T is a light path length between the center of the incidence surface and the center of the emission surface.

2. The optical receptacle according to claim 1, wherein a focal length of the optical receptacle is a negative number.

3. An optical module comprising:
a light-emitting element; and
the optical receptacle according to claim 1 where light emitted from the light-emitting element enters,
wherein the following Equation 3 is satisfied
$$E 1 / E 2 > 1.2 \qquad ( Equation 3 )$$
where E1 is a diameter on the incidence surface of light emitted from the light-emitting element that impinges on the incidence surface, and E2 is a diameter on the emission surface of light emitted from the light-emitting element that is emitted from the emission surface.

4. The optical module according to claim 3, wherein in a cross section including an optical axis of the light-emitting element, a center of the incidence surface and a center of the emission surface, light emitted from a center of a light-emitting surface of the light-emitting element includes light that intersects the optical axis in a region between the incidence surface and the emission surface.

5. The optical module according to claim 3, further comprising a reflection surface configured to reflect, toward the emission surface, light having entered from the incidence surface.

6. A transmission apparatus comprising:
the optical module according to claim 3; and
an optical transmission member where light emitted from the optical receptacle impinges,
wherein the following Equation 4 is satisfied,
$$D 1 / D 2 > 5 \qquad ( Equation 4 )$$
where D1 is a distance between a center of a light-emitting surface of the light-emitting element and a center of the incidence surface, and D2 is a distance between a center of the emission surface and the end surface of the optical transmission member.
